(19) United States
(12) Patent Application Publication
(10) Pub. No.: US 2007/0236191 A1
(43) Pub. Date: Oct. 11, 2007

(54) Boost Regulator with Integrated Load Switch

(75) Inventors: Tim Wen Hui Yu, Fremont, CA (US); Lu Chen, San Jose, CA (US)

Correspondence Address: ADVANCED ANALOGIC TECHNOLOGIES, 830 EAST ARQUES AVE, SUNNYVALE, CA, 94085, US

(73) Assignee: Advanced Analogic Technologies, Inc., Sunnyvale, CA (US)

(21) Appl. No.: 11/279,375

(22) Filed: Apr. 11, 2006

(51) Int. Cl. G05F 1/00

(52) U.S. Cl. 323/282

(57) ABSTRACT

A boost regulator includes a diode D connected between a node V_{X} and an output node V_{OUT}. The node V_{X} is connected to ground by a first switch M1. A second switch M2 and an inductor L are connected in series between the node V_{X} and an input node V_{IN}. The regulator has an enabled state and a disabled state. In the enabled stage, a control circuit turns the second switch on and drives the first switch using a PFM, PWM or other strategy. In the disabled state, control circuit turns the second switch off to prevent current passing through the regulator to the load.

### BACKGROUND OF INVENTION

Switching regulators are intended to be efficient machines for converting an input voltage to an output voltage. The two most common types of switching regulators are Boost (voltage increasing converters) and Buck (voltage decreasing regulators). Both Boost and Buck regulators are very important for battery powered applications such as cellphones.

As shown in FIG. 1A, a traditional implementation for a Boost regulator includes an inductor L connected between an input voltage (V_{BATT} in this case) and a node V_{X}. A switch M1 is connected between the node V_{X} and ground. A diode D is connected between V_{X} and the output node (V_{OUT}) of the regulator. A filtering capacitor connects V_{OUT} to ground. A control circuit turns switch M1 on and off in a repeating pattern. This causes the Boost regulator to have two distinct operational phases. In the first phase, shown in FIG. 1B, the switch M1 is on. During this phase, called the charging phase, the inductor is connected between the battery and ground. This causes the inductor L to store energy in the form of a magnetic field.

In the second, or discharge phase the switch M1 is opened (see FIG. 1C). In this phase the battery, inductor and diode are connected in series with the load. As a result, current flows to the load as the magnetic field previously stored by the inductor collapses. The series connection of the battery and inductor means that current is delivered at greater than battery voltage. As the inductor's magnetic field collapses and the voltage over the inductor falls, the diode prevents current at the load from actually reversing.

In general, switching regulators work in environments where both the input and output voltage are dynamic voltages. Input voltages change as battery voltages decline over time or as other components draw more power. Output voltages change depending on load requirements. Switching regulators react to changes in input and output voltages by varying the amount of time that the switch M1 remains on. This is done using two different methods. In the first method, the switching frequency is varied—as the load on the regulator increases (relative to its supply) the switching frequency is increased. This is known as pulse frequency modulation or PFM. In the second method a fixed switching frequency is used and the amount of time that the switch M1 is turned on is varied. For larger loads, the switches stay on longer. This is known as pulse width modulation of PWM. Of the two methods, PWM is often preferred because it produces noise at a known and therefore filterable fixed frequency. Filtering the noise created by a PFM regulator can be problematic—especially in portable applications.

When turned off, current may flow through the Boost regulator of FIG. 1 from the battery to load. Synchronous regulators, which use a second switch in place of the diode, do not suffer from this limitation. Synchronous designs are not, however always practical. This is especially true as the for higher output voltages. In such cases, it becomes increasingly difficult to fabricate the second switch as a MOS device and MOS is increasingly the technology of choice for power application. Addition of the second switch also requires additional control circuitry which increases cost and complexity.

### SUMMARY OF THE INVENTION

The present invention includes a Boost regulator that includes a current-limited switch to prevent current leakage in a powered off state. The Boost regulator includes a diode connected between a node V_{X} and the output node (V_{OUT}) of the regulator. A filtering capacitor connects V_{OUT} to ground. A first switch M1 is connected between the node V_{X} and ground. A second switch M2 and an inductor are connected in series between an input node V_{IN} and the node V_{X}. A power supply, typically a battery is connected to the input node V_{IN}.

A control circuit coordinates the operation of the two switches. M1 is controlled using any PWM or PFM strategy or any mixture, hybrid or modification of PWM or PFM strategies. M2 is controlled to be on whenever the Boost regulator is operating and off otherwise. The second switch M2 provides the following advantages:
(1) Switch M2 prevents current flowing through the regulator to load when the regulator is powered off.
(2) Switch M2 may be used to sense the current in the inductor L; and
(3) By using slew rate control techniques, switch M2 may be turned on slowly to limit in-rush current improving regulator performance at startup.

### DESCRIPTION OF FIGURES

FIG. 1A is a block diagram of a boost switching regulator.

FIG. 1B is a block diagram showing the boost switching regulator of FIG. 1 during the charge phase of operation.

FIG. 1C is a block diagram showing the boost switching regulator of FIG. 1 during the discharge phase of operation.

FIG. 2 is a block diagram of a Boost type switching regulator as provided by the present invention.

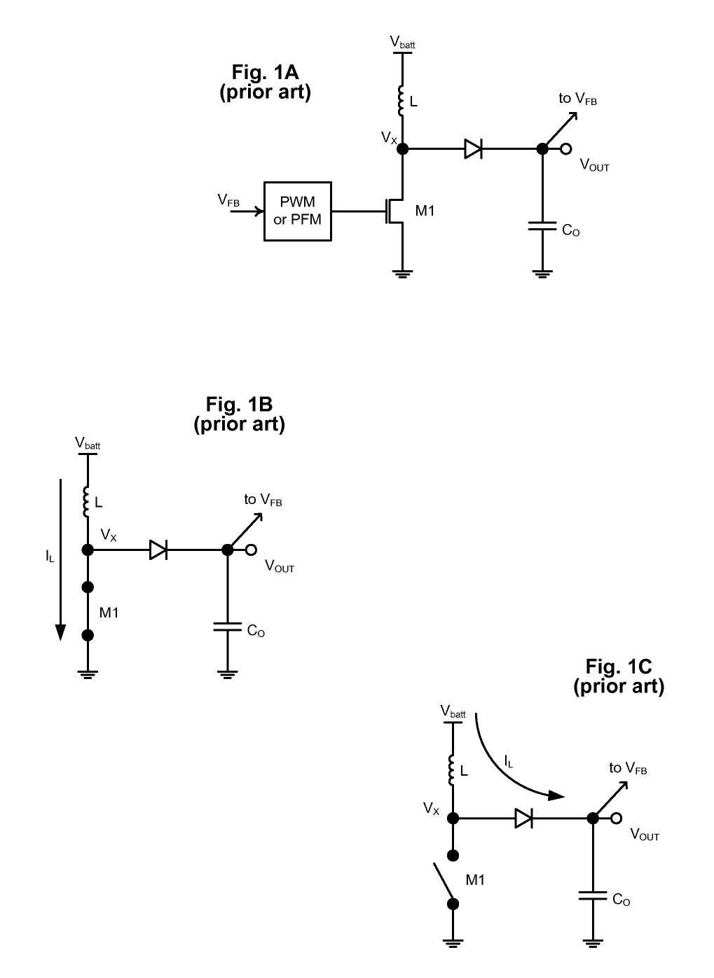

### DESCRIPTION OF INVENTION

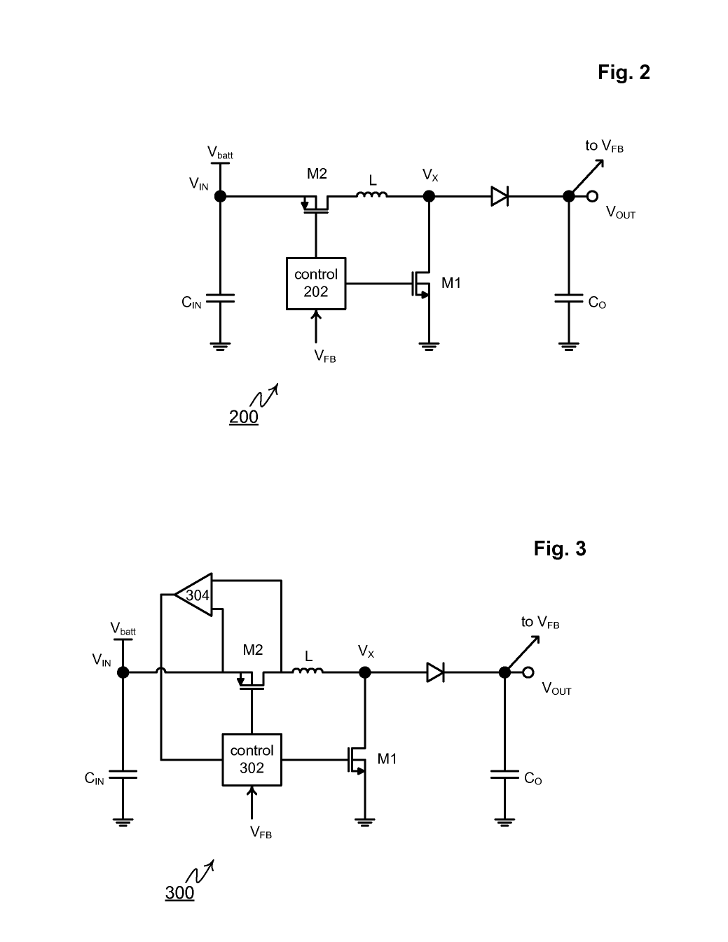

The present invention includes a Boost regulator that includes a current-limited switch to prevent current leakage in a powered off state. As shown in FIG. 2, a representative implementation of the Boost regulator 200 includes a diode D connected between a node V_{X} and an output node V_{OUT}. A filtering capacitor C_{O} connects the node V_{OUT} to ground. A first switch M1 is connected between the node V_{X} and ground. A second switch M2 and an inductor L are connected in series between an input node V_{IN} and the node V_{X}. A power supply, typically a battery is connected to the input node V_{IN}.

Switch M1 is typically implemented as an N-channel MOSFET device. Switch M2 is typically implemented as a slew rate controlled P-channel MOSFET device. Slew rate controlled switches, suitable for implementation of switch M2 are described in U.S. Pat. No. 6,489,829 (incorporated in this document by reference). In addition to slew rate control, switch M2 may be implemented to provide current limiting. Current limiting switches, suitable for implementation of switch M2 are described in U.S. Pat. Nos. 6,465,999 and 6,166,530 (each of which is incorporated in this document by reference). It should be noted that switch M2 is operated at voltages that are close to the input voltage of Boost regulator 200. For this reason, switch M2 can be fabricated from low-voltage processes and may be integrated with other components of switching regulator 200.

A control circuit 202 coordinates the operation of the two switches M1 and M2. M1 is controlled using any PWM or PFM strategy or any mixture, hybrid or modification of PWM or PFM strategies. This specifically includes light load schemes such as burst mode and pulse-skipping. Switch M2 is controlled to be on whenever the Boost regulator 200 is operating and off otherwise. In this way, Switch M2 prevents current flowing through the regulator 200 when the regulator 200 is powered off. When Switch M2 is turned on, its internal slew rate control decreases in-rush current to regulator 200. This improves the performance of regulator 200 as the regulator is turned on.

FIG. 3 shows a second Boost Regulator 300 that implements an additional aspect of the present invention. Boost regulator 300 shares the basic structure described for Boost Regulator 200. To this combination of elements, Boost regulator 300 an amplifier 304 configured to monitor the voltage drop over switch M2. In this way, switch M2 may be used to measure the current flowing through inductor L and determine both its magnitude and polarity. The output of amplifier 304 is provided to control circuit 302 for use as a feedback signal to control the PWM or PFM operation of switch M1.

What is claimed is:

1. A boost regulator that comprises:
a diode D connected between a node V_{X} and an output node V_{OUT};
a first switch M1 connected between the node V_{X} and ground;
a second switch M2 and an inductor L connected in series between an input node V_{IN} and the node V_{X}; and
a control circuit configured to control the first and second switches so that the boost regulator has an enabled state and a disabled state, where the enabled state is characterized by the second switch being continuously on while the first switch is toggled on and off to regulate the current flowing through the inductor and where the disabled state is characterized by the second switch being constantly off.

2. A boost regulator as recited in claim 1 where the second switch is implemented as a slew rate controlled P-channel MOSFET device.

3. A boost regulator as recited in claim 1 where the second switch is monolithically implemented with the control circuit.

4. A boost regulator as recited in claim 1 that further comprises an amplifier connected to monitor the voltage drop over the second switch.

5. A boost regulator as recited in claim 4 in which the first switch is toggled on and off using either a pulse width modulation (PWM) or pulse frequency modulation (PFM) control method.

6. A boost regulator as recited in claim 5 in which the PWM or PFM control method is responsive to the output of the amplifier.

7. A method for operating a switching regulator where the switching regulator includes a diode D connected between a node VX and an output node VOUT, a first switch M1 connected between the node VX and ground; a second switch M2 and an inductor L connected in series between an input node VIN and the node VX, the method comprising:
turning the second switch continuously on and toggling the first switch on and off to regulate the current flowing through the inductor during an enabled state; and
turning the second switch off during a disabled state.

8. A method as recited in claim 7 that further comprises: turning the switch M2 at a controlled rate to progressively increase the current following through the inductor.

9. A method as recited in claim 7 where the second switch is monolithically implemented with the control circuit.

10. A method as recited in claim 7 that further comprises: monitoring the voltage drop over the second switch to sense the current passing through the inductor.

11. A method as recited in claim 10 in which the first switch is toggled on and off using either a pulse width modulation (PWM) or pulse frequency modulation (PFM) control method.

12. A method as recited in claim 11 in which the PWM or PFM control method is responsive to the output of the amplifier.
